(19) United States
(12) Patent Application Publication
(10) Pub. No.: US 2011/0032937 A1
(43) Pub. Date: Feb. 10, 2011

(54) SYSTEM AND METHOD FOR SHARING A PAYLOAD AMONG MULTIPLE HOMED NETWORKS

(76) Inventors: Kenneth Gould, Oakton, VA (US); Howard Pfeffer, Reston, VA (US); Vijay Venkateswaran, Fairfax, VA (US)

Correspondence Address: The Marbury Law Group, PLLC, 11800 SUNRISE VALLEY DRIVE, SUITE 1000, RESTON, VA, 20191, US

(21) Appl. No.: 12/537,484

(22) Filed: Aug. 7, 2009

(51) Int. Cl. H04L 12/56

(52) U.S. Cl. 370/392; 370/401

(57) ABSTRACT

Systems and methods that permit an end device to partition a payload into payload portions for simultaneous transmission over multiple networks so as to increase the effective bandwidth available to the end device. The end device may also receive portions of a partitioned payload via multiple networks and reassemble the payload into its pre-partitioned form.

### BACKGROUND

Broadband networks, such as cable, satellite, DSL and fiber networks carry data in the form of graphics, text, video and audio (collectively, “content”) to and from subscribers. Increasingly, the broadband network connects to multiple in-home networks (IHN). However, an IP end-device, such as a personal computer (PC), has access to only one of these networks at a time.

Historically, a PC is shipped with a single network adapter (usually a configurable dial-up adapter or an Ethernet adapter) that permits connection to a single network. A network adapter may be implemented as a physical device, either an internal card or external device that connects to the PC via a port. A network adapter may also be implemented as software in the form of a virtual adapter.

Under these circumstances, the amount of IHN bandwidth that the PC can demand is limited by the capabilities of that network connection. For example, a PC connected to the IHN via a 10baseT Ethernet connection can demand up to 100 megabits per second (Mbits/s) of bandwidth. A PC connected to the IHN via a wireless G connection may be limited to 54 Mbits/s of bandwidth. However, the PC may be capable of processing data at rates in excess of the speed of the network interface connection. Other home network interfaces may use, for example, the residential power line, telephone lines, coax cable runs (advocated by the Multimedia over Coax Alliance or “MoCA”) to provide connectivity.

While configuring an end device with multiple network interfaces may allow the end device to send and receive payloads simultaneously over multiple networks, the bandwidth of each of the networks is available to only a single interface.

### SUMMARY

Embodiments herein provide systems and methods that permit an end device to partition a payload into payload portions for simultaneous transmission over multiple networks so as to increase the effective bandwidth available to the end device. Additional embodiments permit the end device to receive portions of a partitioned payload via multiple networks and to reassemble the payload into its pre-partitioned form.

### DESCRIPTION OF THE DRAWINGS

The accompanying drawings, which are incorporated herein and constitute part of this specification, illustrate exemplary aspects of the invention. Together with the general description given above and the detailed description given below, the drawings serve to explain features of the various embodiments.

FIG. 1 is a system component diagram illustrating different components of a load sharing system according to the various embodiments.

FIG. 2 is a process flow diagram illustrating the configuration and operation of a payload sharing system according to an embodiment.

FIG. 3 is a process flow diagram illustrating the uploading of a payload according to an embodiment.

FIG. 4 is a process flow diagram illustrating the downloading of a payload according to an embodiment.

FIG. 5 is a component block diagram of a personal computer suitable for use in the various embodiments.

FIG. 6 is a component block diagram of a server device suitable for use in the various embodiments.

### DETAILED DESCRIPTION

As used herein, the term “payload” encompasses a collection of related packets that may represent video content, audio content, photographic content, text content, game content, voice content and multi-media content.

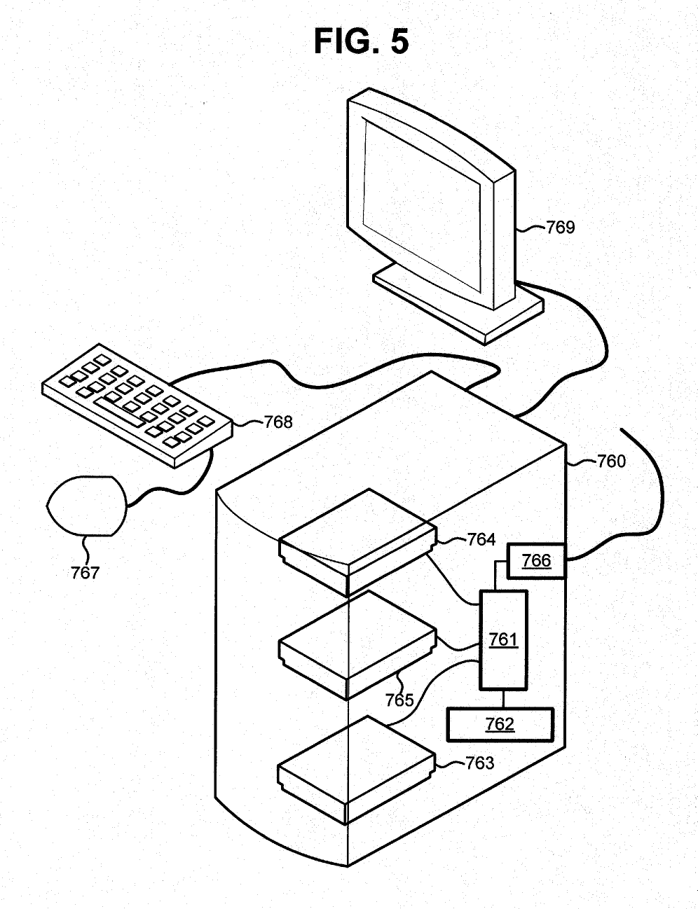

As used herein, the term “end device” encompasses, for example, desktop computers, laptop computers and mobile devices and other processor-equipped devices that may be developed in the future that may be configured to permit a user to interact with other devices over a network. In one embodiment, an end device 104 may be a personal computer. By way of illustration, the functional components of a personal computer 760 are illustrated in FIG. 5. Such a personal computer 760 typically includes a processor 761 coupled to volatile memory 762 and a large capacity nonvolatile memory, such as a disk drive 763. The computer 760 may also include a floppy disc drive 764 and a compact disc (CD) drive 765 coupled to the processor 761. Typically the computer device 760 will also include a pointing device such as a mouse 767, a user input device such as a keyboard 768 and a display 769. The computer device 760 may also include a number of connector ports coupled to the processor 761 for establishing data connections or receiving external memory devices, such as a USB or FireWire® connector sockets or other network connection circuits 766 for coupling the processor 761 to a network. In a notebook configuration, the computer housing includes the pointing device 767, keyboard 768 and the display 769 as is well known in the computer arts.

As used herein, a “server” encompasses a computing device that may be configured to interact in an automated fashion with other devices over a network to serve content and web pages, to issue responses to communications from other network devices and to respond to queries from other network devices.

As used herein, a “gateway” encompasses a computing device that may be configured to provide connections between different networks, including connections between a single “outside network” and multiple “inside networks.”

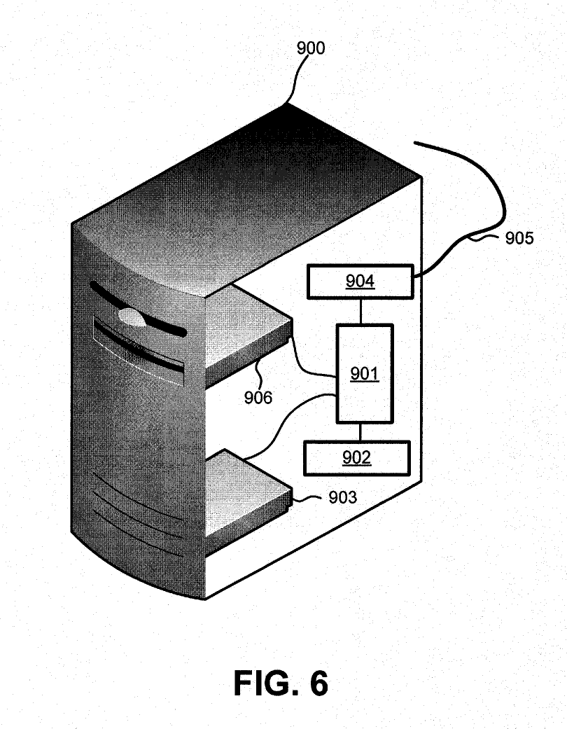

A number of the aspects described below (including broadband home gateway 140) may be implemented with any of a variety of remote server devices, such as the server 900 illustrated in FIG. 6. Such a server 900 typically includes a processor 901 coupled to volatile memory 902 and a large capacity nonvolatile memory, such as a disk drive 903. The server 900 may also include a floppy disk drive and/or a compact disc (CD) drive 906 coupled to the processor 901. The server 900 may also include a number of connector ports 904 coupled to the processor 901 for establishing data connections with network circuits 905.

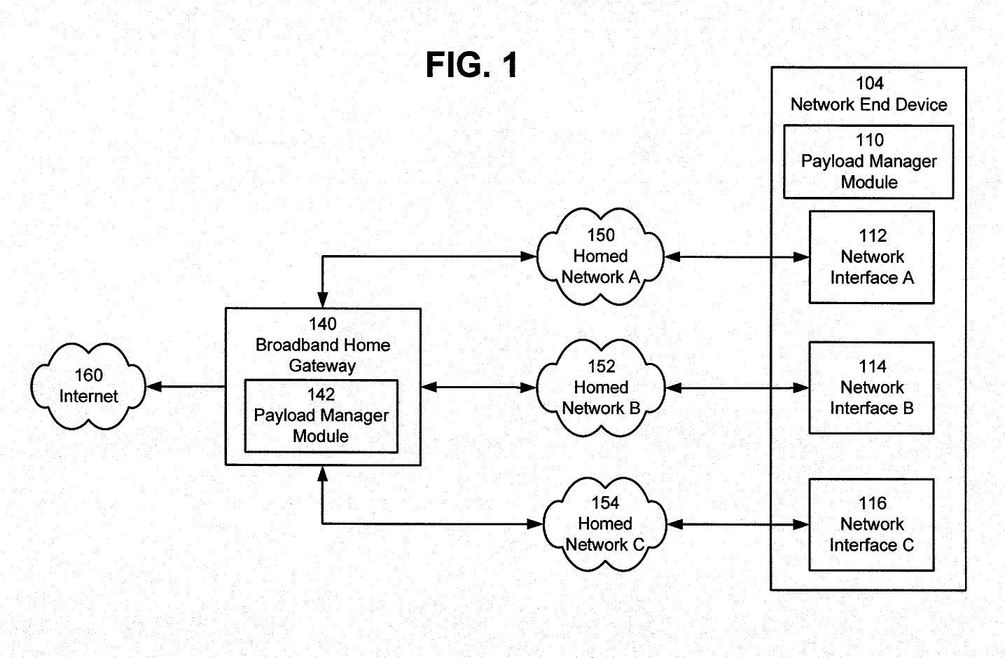

FIG. 1 is a system component diagram illustrating different components of a load sharing system according to the various embodiments. In an embodiment, a broadband home gateway (BHG) 140 provides connections to multiple in-home networks, including the homed network A 150, the homed network B 152, and the homed network 154. By way of illustration and not by way of limitation, the home network A 150 may be a 10/100 Ethernet connection, the homed network B 152 may be an 802.11x wireless connection, and the homed network C 154 may be a MoCA network connection.

The broadband home gateway further comprises a payload manager module 142. The payload manager module 142 operates on both uploaded and downloaded payloads as will be discussed in detail below. The payload manager module 142 may be implemented as a software application that is stored in a memory of the broadband home gateway 140 and executed by a processor of the broadband home gateway 140.

The network end device 104 comprises network interfaces for each of the multiple homed networks. As illustrated in FIG. 1, the network end device 104 comprises a network interface A 112 for connecting to the homed network A 150, a network interface B 114 for connecting to the homed network B 152, and a network interface C 116 for connecting to the homed network C 154. While FIG. 1 illustrates three homed networks and three network interfaces, this is not meant as a limitation.

The network end device 104 further comprises payload manager module 110. The payload manager module 110 operates on both uploaded and downloaded payloads as will be discussed in detail below. The payload manager module 110 may be implemented as a software application that is stored in a memory of the end device 104 and executed by a processor of the end device 104.

In an embodiment, the network end device 104 registers with the broadband home gateway 140. The registration of the network end device 104 with the broadband home gateway 140 facilitates the routing of payload portions from the end device 104 to the broadband home gateway 140.

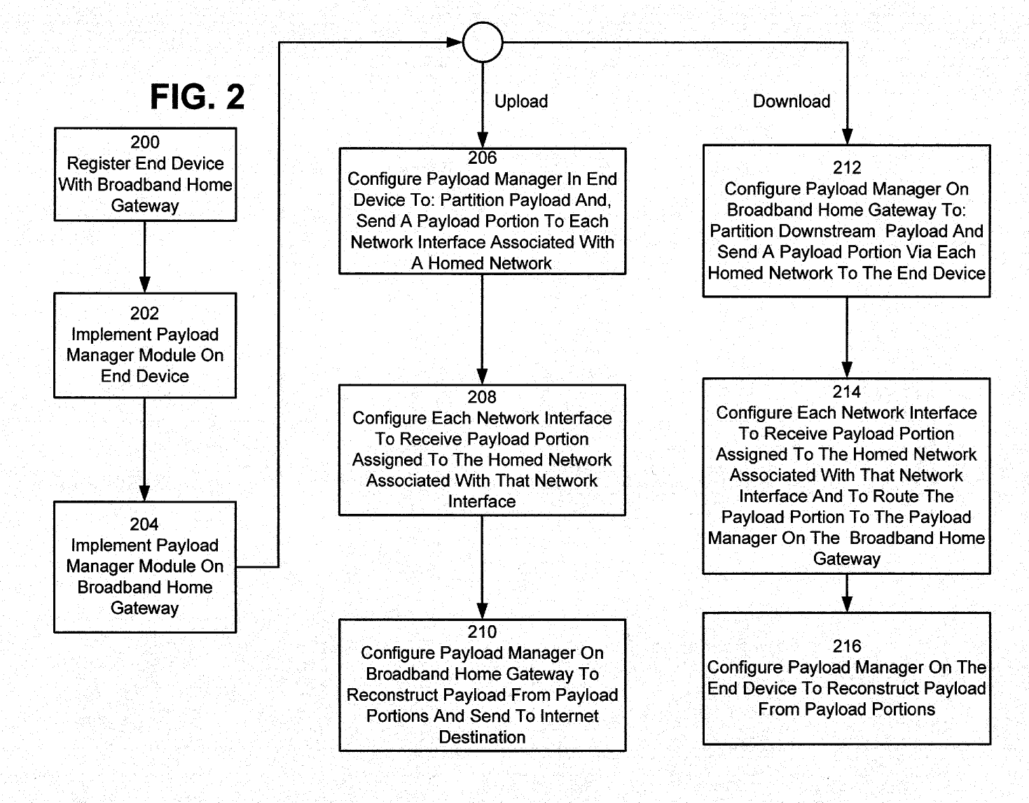

FIG. 2 is a process flow diagram illustrating a process for configuring a payload sharing system according to an embodiment.

The end device 104 is registered with the broadband home gateway 140 (block 200). A payload manager module 110 is implemented on the end device 104 (block 202). A payload manager module 142 is implemented on the broadband home gateway 140 (block 204).

The payload manager module 110 implemented on end device 104 is configured to partition an upload payload into “payload portions,” and to send a payload portion to each network interface associated with a homed network (block 206).

The payload manager module 142 implemented on the broadband home gateway 140 is configured to receive all of the upload payload portions, to reconstruct the payload from the payload portions, and to send the payload to its destination (block 210).

The payload manager module 142 implemented on the broadband home gateway 140 is configured to receive a payload download from the Internet destined for the end device 104, to partition the payload into “payload portions,” and to send one of download payload portions to each homed network (block 212). Each of the network interfaces associated with the homed networks is configured to receive a download payload portion and route it to the end device 104 (block 214). The payload module 110 implemented on end device 104 is configured to receive the payload portions from the home networks and to reconstruct the payload from the payload portions (block 216).

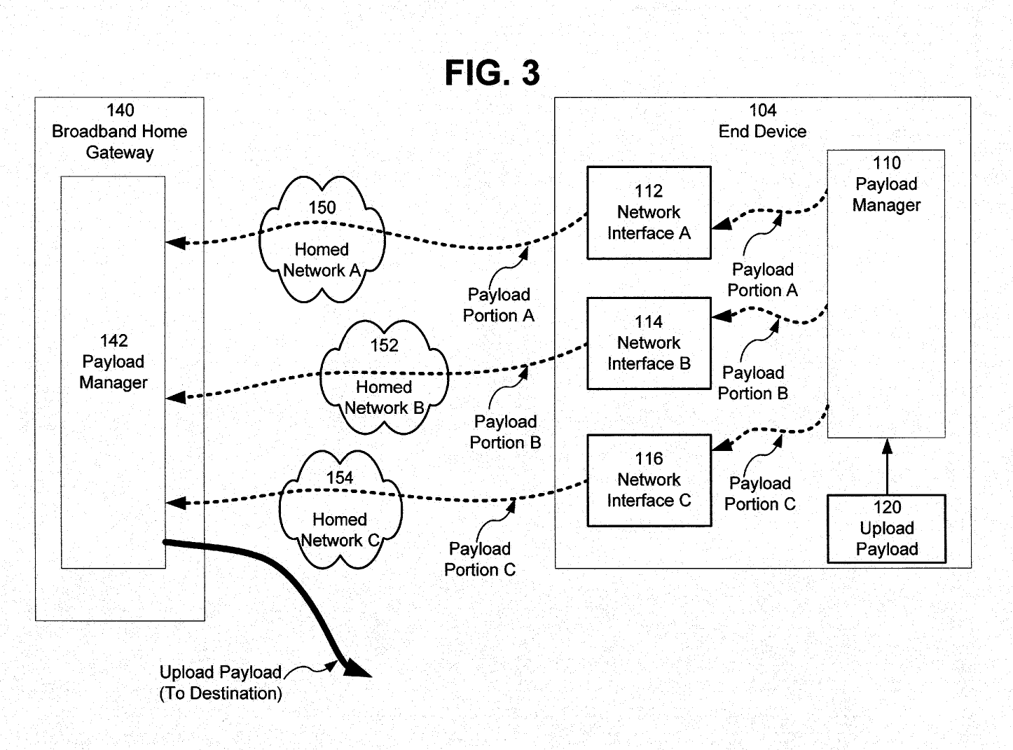

FIG. 3 is a process flow diagram illustrating the uploading of a payload according to an embodiment. In this embodiment, end device 104 desires to send a payload to a device (not illustrated) with an internet protocol (IP) address.

The payload is processed by a payload manager module 110 to partition the payload into portions. As illustrated in FIG. 3, the payload has been partitioned into three portions (payload portions A, B, and C) by payload manager 110. However this is not meant as a limitation. In an embodiment, the payload manager module 110 on the end device 104 sends a payload portion to each of the network interfaces (network interface A 112, network interface B 114 and network interface C 116.

The respective payload portions A, B and C are sent to the broadband home gateway 140. The respective payload portions A, B, C and D are routed to the broadband home gateway 140 via the home network associated with a particular network interface. Thus, the payload portion A is sent through the network interface A 112 over the homed network A 150 to the broadband home gateway 140. Similarly, payload portion B is sent through the network interface B 114 over the homed network B 152 to the broadband home gateway 140, and the payload portion C is sent through the network interface C 116 over the homed network C 154 to the broadband home gateway 140. The payload portions A, B, and C are processed by payload manager module 142 implemented on the broadband home gateway 140. The payload manager 142 is configured to receive all of the payload portions, to reconstruct the payload from the payload portions, and to send the payload to its destination (not illustrated).

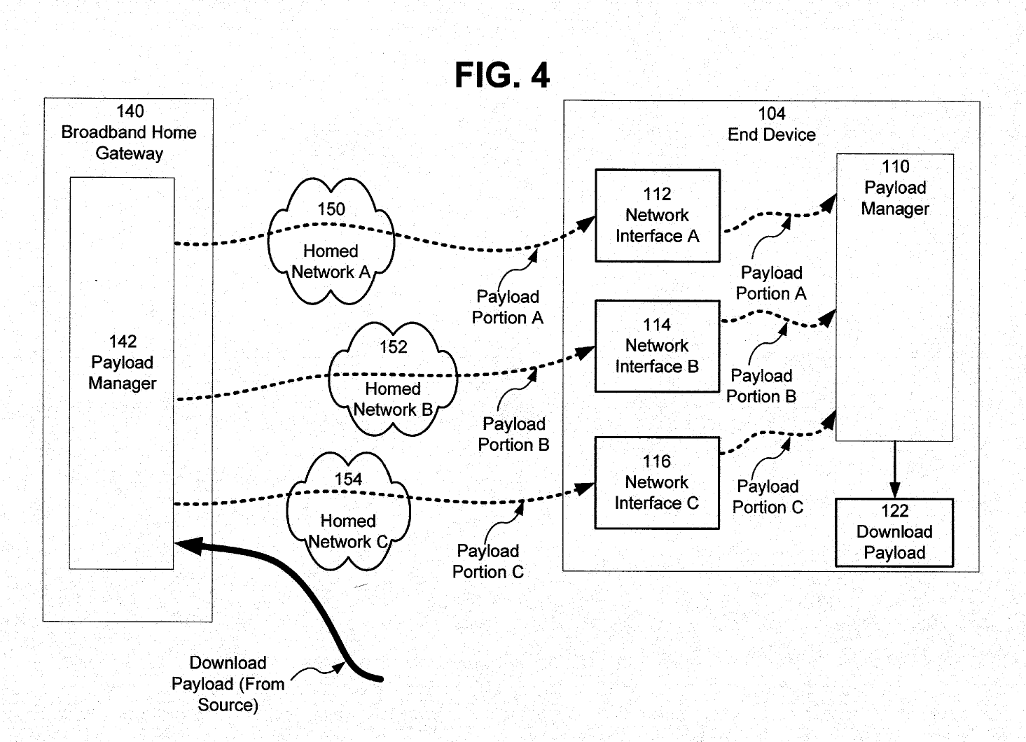

FIG. 4 is a process flow diagram illustrating the downloading of a payload according to an embodiment. In this embodiment, an end device 104 has requested a payload from a device (not illustrated) with an internet protocol (IP) address. In this embodiment, all download requests are routed through the broadband home gateway 140 and all responses are returned to the broadband home gateway 140. The broadband home gateway 140 then decides whether partitioning of the payload is required and, if so, requests that a payload manager module 142 perform this task.

The payload is processed by the payload manager module 142 implemented on the broadband home gateway 140 to partition the payload into portions. As illustrated in FIG. 4, the payload has been partitioned into three portions (payload portions A, B, and C respectively). However, this is not meant as a limitation. In an embodiment, the payload manager module 142 on the broadband home gateway 140 determines the number of available homed networks. In this context, an available homed network is a home network that is: 1) accessible; 2) has available bandwidth; 3) and has an established connection to a network interface associated with end device 104. The payload manager 142 will divide the payload by the number of active home networks. In the embodiment illustrated in FIG. 4, the number of active homed networks is three. In this embodiment, the payload manager 142 would divide the payload into three portions and send a portion through each of the homed networks 150, 152 and 154.

The respective payload portions A, B, and C are received by the end device 104 and processed by the payload manager module 110 implemented on the end device 104. The payload manager 110 is configured to receive all of the payload portions and to reconstruct the payload from the payload portions.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Further, words such as “thereafter,” “then,” “next,” etc. are not intended to limit the order of the steps; these words are simply used to guide the reader through the description of the methods.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of the computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be stored on or transmitted over as one or more instructions or code on a computer-readable medium. The steps of a method or algorithm disclosed herein may be embodied in a processor-executable software module which may reside on a computer-readable medium. Computer-readable media includes both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disc storage, magnetic disk storage or other magnetic storage devices, or any other medium that may be used to carry or store desired program code in the form of instructions or data structures that may be accessed by a computer.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a machine readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the scope of the invention. Thus, the present invention is not intended to be limited to the embodiments shown herein but is to be accorded the widest scope consistent with the principles and novel features disclosed herein. Further, any reference to claim elements in the singular, for example, using the articles “a,” “an,” or “the,” is not to be construed as limiting the element to the singular.

What is claimed is:

1. A method for sharing a payload among multi-homed networks comprising:
configuring an end device to communicate with a broadband home gateway via a plurality of homed networks;
generating a payload at the end device, wherein the payload comprises data and an address and wherein the end device comprises a plurality of network interfaces each associated with one of the plurality of homed networks;
partitioning the payload into portions, wherein a number of portions is equal to a number of homed networks;
assigning a payload portion to each of the plurality of network interfaces;
sending the payload portions to the broadband home gateway via the plurality of homed networks;
receiving the payload portions at the broadband home gateway;
reconstructing the payload from the received payload portions; and
sending the payload to the destination address via a network.

2. The method of claim 1, wherein the end device is selected from the group consisting of a computer, a laptop, a PDA, and a video game console.

3. The method of claim 1, wherein the plurality of homed networks is selected from the group consisting of a wireless network, an Ethernet network and a MoCA network.

4. The method of claim 1, wherein the payload is selected from the group consisting of a document, an image, a video, audio data, game data, and a software program.

5. A method for sharing a payload among multi-homed networks comprising:
configuring an end device to communicate with a broadband home gateway via a plurality of homed networks;
receiving at the broadband home gateway a request for a payload from the end device via one of the plurality of homed networks, wherein the payload request comprises a request for data from a source having a source address;
sending the payload request from the broadband home gateway to the source address via a network;
receiving the payload at the broadband home gateway from the source;
partitioning the payload into portions, wherein a number of portions is equal to a number of homed networks;
assigning a payload portion to each of the plurality of network interfaces;
sending the payload portions to the end device via the plurality of homed networks;
receiving the payload portions at the end device; and
reconstructing the payload from the received payload portions.

6. The method of claim 5, wherein the end device is selected from the group consisting of a computer, a laptop, a PDA, and a video game console.

7. The method of claim 5, wherein the plurality of homed networks is selected from the group consisting of a wireless network, an Ethernet network and a MoCA network.

8. The method of claim 5, wherein the payload is selected from the group consisting of a document, an image, a video, audio data, game data, and a software program.

9. A system for sharing a payload among multi-homed networks comprising:
a network;
a plurality of homed networks;
an end device, wherein the end device comprises a plurality of network interfaces each associated with one of the plurality of homed network; and
a broadband home gateway,
wherein the end device is configured to:
communicate with the broadband home gateway via the plurality of homed networks;
generate a payload, wherein the payload comprises data and an address;
partition the payload into portions, wherein a number of portions is equal to a number of homed networks;
assign a payload portion to each of the plurality of network interfaces; and
send the payload portions to the broadband home gateway via the plurality of homed networks; and
wherein the broadband home gateway is configured to:
receive the payload portions from the end device;
reconstruct the payload from the received payload portions; and
send the payload to the destination address via a network.

10. The system of claim 9, wherein the end device is selected from the group consisting of a computer, a laptop, a PDA, and a video game console.

11. The system of claim 9, wherein the plurality of homed networks is selected from the group consisting of a wireless network, an Ethernet network and a MoCA network.

12. The system of claim 9, wherein the payload is selected from the group consisting of a document, an image, a video, audio data, game data, and a software program.

13. A system for sharing a payload among multi-homed networks comprising:
a network;
a plurality of homed networks;
an end device, wherein the end device comprises a plurality of network interfaces each associated with one of the plurality of homed network; and
a broadband home gateway,
wherein the end device is configured to:
communicate with the broadband home gateway via the plurality of homed networks;
generate a request for a payload, wherein the payload request comprises a request for data from a source having a source address; and
send the payload request to the broadband gateway via one of the plurality of homed networks; and
wherein the broadband home gateway is configured to:
receive the request for a payload from the end device via one of the plurality of homed networks;
send the payload request to the source address via a network;
receive the payload gateway from the source;
partition the payload into portions, wherein a number of portions is equal to a number of homed networks;
assign a payload portion to each of the plurality of network interfaces; and
send the payload portions to the end device via the plurality of homed networks; and
wherein the end device is further configured to:
receive the payload portions at the end device; and
reconstruct the payload from the received payload portions.

14. The system of claim 13, wherein the end device is selected from the group consisting of a computer, a laptop, a PDA, and a video game console.

15. The system of claim 13, wherein the plurality of homed networks is selected from the group consisting of a wireless network, an Ethernet network and a MoCA network.

16. The system of claim 13, wherein the payload is selected from the group consisting of a document, an image, a video, audio data, game data, and a software program.
